(19) United States
(12) Patent Application Publication
(10) Pub. No.: US 2010/0299938 A1
(43) Pub. Date: Dec. 2, 2010

(54) Pruning Hook with Hidden Driving Mechanism

(76) Inventor: Shih-Piao Wu, Lu Kang Town (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/471,605

(22) Filed: May 26, 2009

(51) Int. Cl. A01G 3/08

(52) U.S. Cl. 30/249

(57) ABSTRACT

A pruning hook includes an extension shank (10), a blade unit (40) including a fixed blade (42) mounted on the extension shank and a movable blade (41) pivotally connected with the fixed blade, a driving cord (100) to drive the movable blade, a sliding member (20) movably mounted in the extension shank to drive the driving cord, a control cord (200) mounted in the extension shank to drive the sliding member, and a control member (30) movably mounted on the extension shank to drive the control cord. Thus, the extension shank protects the control cord and the driving cord to prevent the control cord and the driving cord from being hooked or scratched by foreign objects, such as branches and the like, during operation of the blade unit.

### BACKGROUND OF THE INVENTION

1. Field of the Invention

The present invention relates to a shearing tool and, more particularly, to a pruning hook for a gardening purpose to shear branches or leaves at a higher location.

2. Description of the Related Art

A conventional pruning hook in accordance with the prior art shown in FIG. 6 comprises an extension shank 60, a blade unit 70 including a fixed blade 71 mounted on the extension shank 60 and a movable blade 72 pivotally connected with and movable relative to the fixed blade 71, a linkage 80 pivotally connected with the fixed blade 71 and the movable blade 72 of the blade unit 70, an elastic member 81 biased between the fixed blade 71 of the blade unit 70 and the linkage 80, a first pulley 82 mounted on the linkage 80, a second pulley 61 mounted on the extension shank 60, a slide 62 movably mounted on the extension shank 60, and a driving cord 90 having a first end secured to the linkage 80 and a second end secured to the slide 62. The driving cord 90 encircles the first pulley 82 and the second pulley 61.

In operation, when the slide 62 is moved outwardly relative to the blade unit 70, the driving cord 90 is driven by the slide 62 to drive the linkage 80 which drives the movable blade 72 of the blade unit 70 to move toward the fixed blade 71 of the blade unit 70 so as to perform a cutting action. On the contrary, when the pulling force applied on the slide 62 is removed, the movable blade 72 of the blade unit 70 is driven by the restoring force of the elastic member 81 to move outwardly relative to the fixed blade 71 of the blade unit 70 so that the blade unit 70 is opened at a normal state.

However, the driving cord 90 is exposed from the extension shank 60 completely, so that the driving cord 90 is easily hooked or scratched by foreign objects, such as branches and the like, during operation of the blade unit 70 so that the driving cord 90 is easily torn or broken due to an external force caused by the foreign objects.

### BRIEF SUMMARY OF THE INVENTION

The primary objective of the present invention is to provide a pruning hook with a hidden driving mechanism.

Another objective of the present invention is to provide a pruning hook, wherein most of the control cord and the driving cord are disposed in the extension shank, and the extension shank protects the control cord and the driving cord to prevent the control cord and the driving cord from being hooked or scratched by foreign objects, such as branches and the like, during operation of the blade unit so that the control cord and the driving cord will not be torn or broken due to an external force caused by the foreign objects so as to enhance the lifetime of the control cord and the driving cord.

A further objective of the present invention is to provide a pruning hook, wherein the control cord is guided by the control pulley, and the driving cord is guided by the first guide pulley and the second guide pulley of the blade unit so that the control cord and the driving cord are operated smoothly and stably to facilitate operation of the blade unit.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a pruning hook in accordance with the preferred embodiment of the present invention.

FIG. 2 is an exploded perspective view of the pruning hook as shown in FIG. 1.

FIG. 3 is a perspective broken view of the pruning hook as shown in FIG. 1.

FIG. 4 is a side cross-sectional view of the pruning hook as shown in FIG. 1.

FIG. 5 is a schematic operational view of the pruning hook as shown in FIG. 4 in use.

FIG. 6 is a side view of a conventional pruning hook in accordance with the prior art.

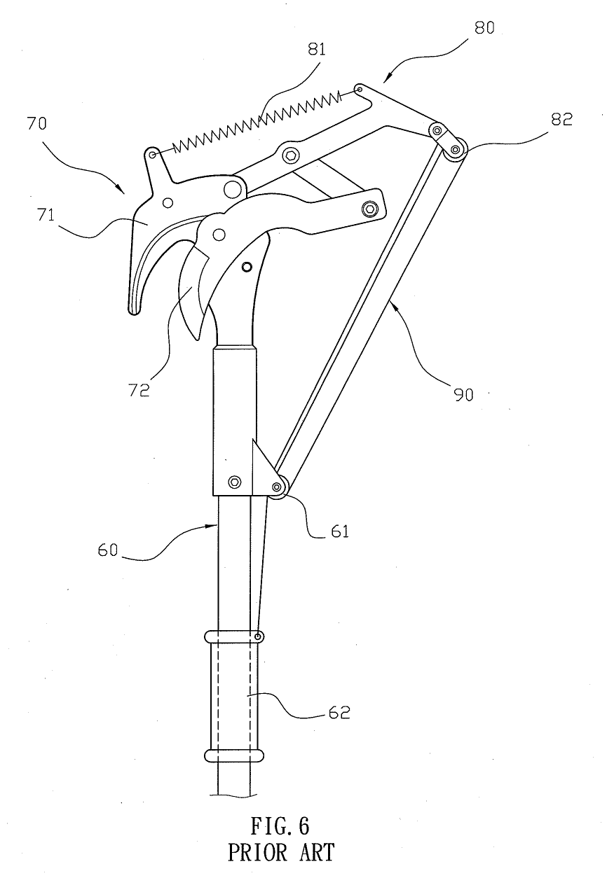

### DETAILED DESCRIPTION OF THE INVENTION

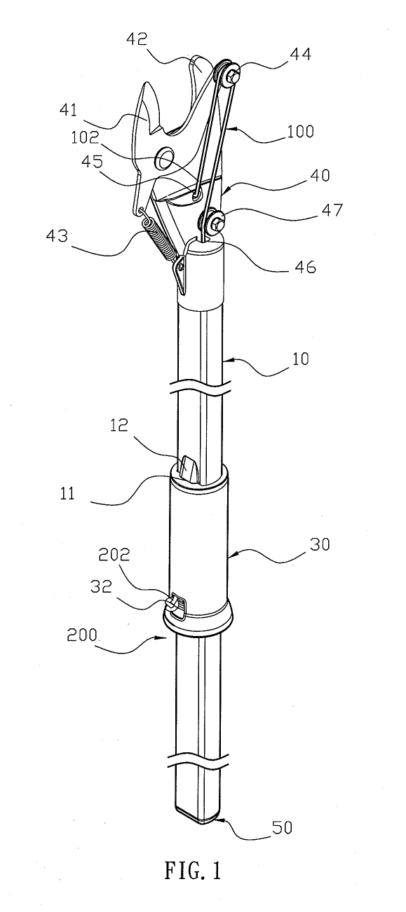

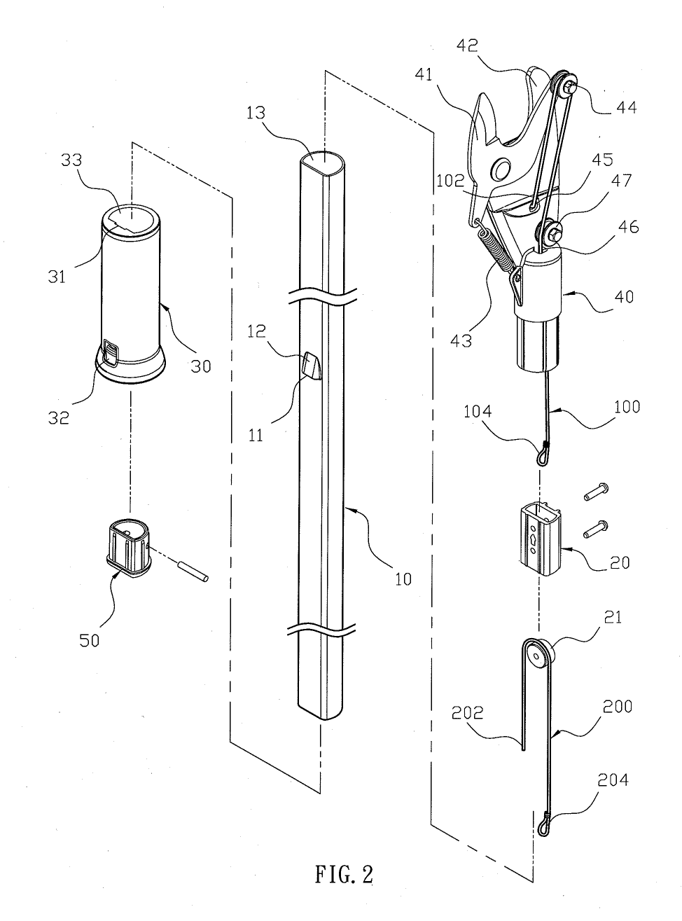

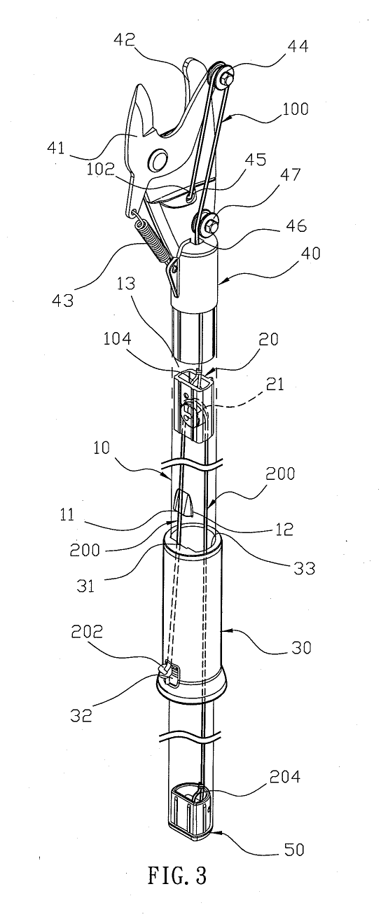

Referring to the drawings and initially to FIGS. 1-4, a pruning hook in accordance with the preferred embodiment of the present invention comprises an extension shank 10, a blade unit 40 including a fixed blade 42 mounted on the extension shank 10 and a movable blade 41 pivotally connected with and movable relative to the fixed blade 42, a driving cord 100 connected with the movable blade 41 of the blade unit 40 to drive the movable blade 41 of the blade unit 40 to move relative to the fixed blade 42 of the blade unit 40, a sliding member 20 movably mounted in the extension shank 10 and connected with the driving cord 100 to drive and move the driving cord 100, a control cord 200 mounted in the extension shank 10 and connected with the sliding member 20 to drive and move the sliding member 20, and a control member 30 movably mounted on the extension shank 10 and connected with the control cord 200 to drive and move the control cord 200.

The extension shank 10 is a hollow body and has a substantially semi-circular cross-sectional profile. The extension shank 10 has an inner portion provided with a receiving chamber 13 to receive the driving cord 100, the sliding member 20 and the control cord 200. The extension shank 10 has a side provided with a protruding stop block 12. The stop block 12 of the extension shank 10 has an inner portion provided with a passage 11 connected to the receiving chamber 13 of the extension shank 10 to allow passage of the control cord 200.

The sliding member 20 is a hollow body. A control pulley 21 is rotatably mounted in the sliding member 20.

The control cord 200 is partially received in the sliding member 20 and is pivotally mounted on the control pulley 21 to drive and move the control pulley 21 and the sliding member 20 relative to the extension shank 10. The control cord 200 is hidden in the receiving chamber 13 of the extension shank 10 and has a first end 202 extending outwardly from the extension shank 10 and secured in the control member 30 to move in concert with the control member 30. The first end 202 of the control cord 200 passes through and protrudes outwardly from the passage 11 of the stop block 12. The control cord 200 has a second end 204 secured in a rear end of the extension shank 10. A fixing seat 50 is secured in the rear end of the extension shank 10, and the second end 204 of the control cord 200 is secured in the fixing seat 50. The fixing seat 50 is received in the receiving chamber 13 of the extension shank 10.

The control member 30 has an inner portion provided with a slideway 33 slidably mounted on the extension shank 10. The slideway 33 of the control member 30 has a substantially semi-circular cross-sectional profile. The control member 30 has a side provided with a guide channel 31 connected to the slideway 33 to allow passage of the control cord 200. The guide channel 31 of the control member 30 extends in a longitudinal direction of the control member 30. The control member 30 has a periphery provided with a fixing portion 32 connected to the guide channel 31 to fix the first end 202 of the control cord 200 so that the first end 202 of the control cord 200 is secured on the control member 30. The control member 30 is located between the stop block 12 of the extension shank 10 and the fixing seat 50. The control member 30 is located outside of the extension shank 10 and is movable on the extension shank 10 to abut the stop block 12 of the extension shank 10 so that the stop block 12 of the extension shank 10 can limit a further movement of the control member 30.

The blade unit 40 is mounted on a front end of the extension shank 10. The fixed blade 42 of the blade unit 40 has a side provided with a fixing hole 45. The fixed blade 42 of the blade unit 40 has an inner portion provided with a connecting hole 46 connected to the receiving chamber 13 of the extension shank 10 to allow passage of the driving cord 100. The blade unit 40 further includes a first guide pulley 44 rotatably mounted on a first end of the movable blade 41, an elastic member 43 biased between a second end of the movable blade 41 and the fixed blade 42 to drive the movable blade 41 to move outwardly relative to the fixed blade 42, and a second guide pulley 47 rotatably mounted on the fixed blade 42. The second guide pulley 47 of the blade unit 40 is located beside the connecting hole 46 of the fixed blade 42.

The driving cord 100 is pivotally mounted on the first guide pulley 44 of the blade unit 40 to drive the movable blade 41 of the blade unit 40 to move toward the fixed blade 42 of the blade unit 40. The driving cord 100 passes through the second guide pulley 47 of the blade unit 40 and extends through the connecting hole 46 of the fixed blade 42 into the receiving chamber 13 of the extension shank 10. The driving cord 100 has a first end 102 secured in the fixing hole 45 of the fixed blade 42 and a second end 104 secured in the sliding member 20 to move in concert with the sliding member 20. The driving cord 100 co-operates with the control cord 200 to function as a driving mechanism to drive the blade unit 40.

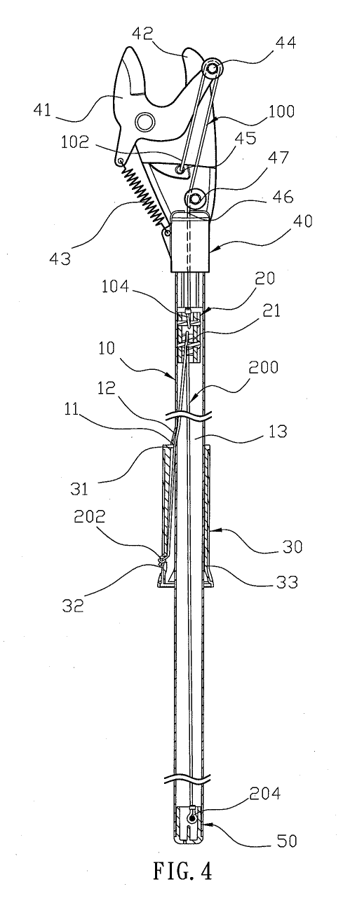

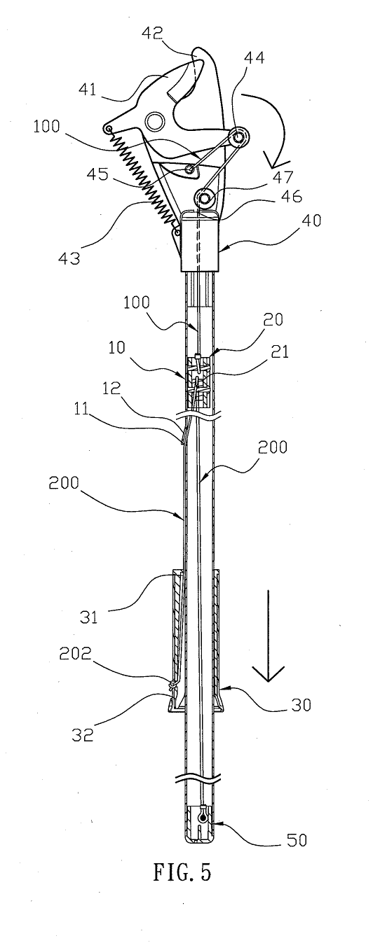

In operation, referring to FIGS. 4 and 5 with reference to FIGS. 1-3, when the control member 30 is moved outwardly relative to the blade unit 40, the control cord 200 is driven by the control member 30 to move the control pulley 21 which moves the sliding member 20 which moves the driving cord 100 which moves the first guide pulley 44 which drives the movable blade 41 of the blade unit 40 to move toward the fixed blade 42 of the blade unit 40 as shown in FIG. 5 so as to perform a cutting action.

On the contrary, when the pulling force applied on the control member 30 is removed, the movable blade 41 of the blade unit 40 is driven by the restoring force of the elastic member 43 to move outwardly relative to the fixed blade 42 of the blade unit 40 as shown in FIG. 4 so that the blade unit 40 is opened at a normal state. At this time, the control member 30 is moved to abut the stop block 12 of the extension shank 10 to limit a further movement of the control member 30.

Accordingly, most of the control cord 200 and the driving cord 100 are disposed in the extension shank 10, and the extension shank 10 protects the control cord 200 and the driving cord 100 to prevent the control cord 200 and the driving cord 100 from being hooked or scratched by foreign objects, such as branches and the like, during operation of the blade unit 40 so that the control cord 200 and the driving cord 100 will not be torn or broken due to an external force caused by the foreign objects so as to enhance the lifetime of the control cord 200 and the driving cord 100. In addition, the control cord 200 is guided by the control pulley 21, and the driving cord 100 is guided by the first guide pulley 44 and the second guide pulley 47 of the blade unit 40 so that the control cord 200 and the driving cord 100 are operated smoothly and stably to facilitate operation of the blade unit 40.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A pruning hook, comprising:
an extension shank (10);
a blade unit (40) including a fixed blade (42) mounted on the extension shank and a movable blade (41) pivotally connected with and movable relative to the fixed blade;
a driving cord (100) connected with the movable blade of the blade unit to drive the movable blade of the blade unit to move relative to the fixed blade of the blade unit;
a sliding member (20) movably mounted in the extension shank and connected with the driving cord to drive and move the driving cord;
a control cord (200) mounted in the extension shank and connected with the sliding member to drive and move the sliding member;
a control member (30) movably mounted on the extension shank and connected with the control cord to drive and move the control cord.

2. The pruning hook of claim 1, wherein the extension shank has an inner portion provided with a receiving chamber (13) to receive the driving cord, the sliding member and the control cord.

3. The pruning hook of claim 2, wherein
the extension shank has a side provided with a protruding stop block (12);
the stop block of the extension shank has an inner portion provided with a passage (11) connected to the receiving chamber of the extension shank to allow passage of the control cord.

4. The pruning hook of claim 1, further comprising:
a control pulley (21) rotatably mounted in the sliding member;
wherein the control cord is pivotally mounted on the control pulley to drive and move the control pulley and the sliding member relative to the extension shank.

5. The pruning hook of claim 3, wherein the control cord has a first end (202) extending outwardly from the extension shank and secured in the control member to move in concert with the control member.

6. The pruning hook of claim 5, wherein the control cord has a second end (204) secured in a rear end of the extension shank.

7. The pruning hook of claim 6, further comprising:
a fixing seat (50) secured in the rear end of the extension shank;
wherein the second end of the control cord is secured in the fixing seat;
the fixing seat is received in the receiving chamber of the extension shank.

8. The pruning hook of claim 5, wherein the control member has an inner portion provided with a slideway (33) slidably mounted on the extension shank.

9. The pruning hook of claim 8, wherein the control member has a side provided with a guide channel (31) connected to the slideway to allow passage of the control cord.

10. The pruning hook of claim 9, wherein the control member has a periphery provided with a fixing portion (32) connected to the guide channel to fix the first end of the control cord so that the first end of the control cord is secured on the control member.

11. The pruning hook of claim 2, wherein
the fixed blade of the blade unit has an inner portion provided with a connecting hole (46) connected to the receiving chamber of the extension shank to allow passage of the driving cord;
the driving cord extends through the connecting hole of the fixed blade into the receiving chamber of the extension shank.

12. The pruning hook of claim 11, wherein
the blade unit further includes:
a first guide pulley (44) rotatably mounted on a first end of the movable blade;
an elastic member (43) biased between a second end of the movable blade and the fixed blade to drive the movable blade to move outwardly relative to the fixed blade;
a second guide pulley (47) rotatably mounted on the fixed blade;
the driving cord is pivotally mounted on the first guide pulley of the blade unit to drive the movable blade of the blade unit to move toward the fixed blade of the blade unit;
the driving cord passes through the second guide pulley of the blade unit.

13. The pruning hook of claim 12, wherein
the fixed blade of the blade unit has a side provided with a fixing hole (45);
the driving cord has a first end (102) secured in the fixing hole of the fixed blade and a second end (104) secured in the sliding member to move in concert with the sliding member.

14. The pruning hook of claim 5, wherein the first end of the control cord passes through and protrudes outwardly from the passage of the stop block.

15. The pruning hook of claim 9, wherein
the extension shank is a hollow body and has a substantially semi-circular cross-sectional profile;
the sliding member is a hollow body;
the slideway of the control member has a substantially semi-circular cross-sectional profile.

16. The pruning hook of claim 2, wherein
the control cord is partially received in the sliding member;
the control cord is hidden in the receiving chamber of the extension shank.

17. The pruning hook of claim 3, wherein
the control member is located between the stop block of the extension shank and the fixing seat;
the control member is located outside of the extension shank and is movable on the extension shank to abut the stop block of the extension shank so that the stop block of the extension shank can limit a further movement of the control member.

18. The pruning hook of claim 10, wherein the guide channel of the control member extends in a longitudinal direction of the control member.

19. The pruning hook of claim 13, wherein the blade unit is mounted on a front end of the extension shank.

20. The pruning hook of claim 13, wherein the second guide pulley of the blade unit is located beside the connecting hole of the fixed blade.
